(19) United States
(12) Patent Application Publication
(10) Pub. No.: US 2026/0149199 A1
(43) Pub. Date: May 28, 2026

(54) HOT STICK MOUNTED CLAMP DEVICE

(71) Applicant: Shayne Zimmerman, Cheyenne, WY (US)

(72) Inventor: Shayne Zimmerman, Cheyenne, WY (US)

(21) Appl. No.: 19/399,885

(22) Filed: Nov. 25, 2025

Related U.S. Application Data
(60) Provisional application No. 63/724,515, filed on Nov. 25, 2024.

(51) Int. Cl. H01R 11/14; H02G 1/02

(52) U.S. Cl. CPC H01R 11/14; H02G 1/02

(57) ABSTRACT

A clamp device includes an end cap having a sidewall enclosing a hollow interior for receiving an operative end of a hot stick. A first jaw is fixedly mounted to the end cap. A second jaw movably engages the first jaw to grip an object. A support structure is provided to which the second jaw is fixedly mounted. The support structure passes through an opening in the end cap and is movably connected to either the end cap or first jaw such that the second jaw engages the first jaw upon displacement of the support structure. A connector of the support structure connects to a movable connector of the hot stick such that the support structure is displaced upon displacement of the movable connector, thereby engaging the second jaw with the first jaw to grip the object, wherein a reverse displacement of the movable connector releases the object.

### CROSS-REFERENCE TO RELATED APPLICATIONS

This non-provisional application claims priority to U.S. Provisional Patent Application Ser. No. 63/724,515, filed on Nov. 25, 2024.

### I. BACKGROUND

### A. Technical Field

This invention pertains to the field of a hot stick connector for attachment and detachment from a conductor in connection with the commercial distribution of electrical light and power.

### B. Description of Related Art

Electrical workers such as linemen use grounding cables to help manage dangerous voltages and currents in de-energized power lines and electrical equipment. Ground clamps, used to make the grounding connection, are intended to be installed and removed using an insulating tool such as hot stick to keep the worker at a safe distance from the electrical hazard.

Hot sticks are insulated poles commonly used in the electric power distribution industry for protecting utility workers while engaging high voltage power lines. Such hot sticks include tools such as hooks and probes attached to the ends for performing various tasks on power line components.

### II. SUMMARY

Provided in this disclosure is a clamp device removably mounted to an electrical hot stick. The clamp device includes an end cap having a sidewall enclosing a hollow interior for receiving an operative end of the hot stick. A first jaw is fixedly mounted to the end cap. A second jaw is configured for movably engaging the first jaw to grip an object. A support structure is provided to which the second jaw is fixedly mounted. The support structure passes through an opening in the end cap and is movably connected to either the end cap or first jaw such that the second jaw engages the first jaw upon displacement of the support structure. A connector of the support structure connects to a movable connector of the hot stick such that the support structure is displaced upon displacement of the movable connector, thereby engaging the second jaw with the first jaw to grip the object, wherein a reverse displacement of the movable connector releases the object.

In one aspect, the end cap has a generally cylindrical side wall having an open cylindrical end and a closed cylindrical end. The open cylindrical end receives the operative end of the hot stick and the closed cylindrical end is a solid piece formed integrally with the cylindrical side wall and includes the opening for passing through the support structure. The movable connector of the hot stick is a hook and the connector of the support structure is a loop to which the hook is connected.

In one embodiment, the first jaw is a lower jaw fixedly mounted to the end cap and the second jaw is a movable upper jaw. The support structure includes one or more longitudinal bars configured for slidably passing through the opening in the end cap such that linear displacement of the movable connector produces linear displacement of the support structure, thereby linearly displacing the upper jaw into engagement with the lower jaw. In a particular aspect, the support structure includes a pair of parallel bars that slidably pass through a respective pair of openings in the end cap, and the upper jaw is fixedly mounted to both parallel bars.

In an alternate embodiment, the first jaw is a fixedly mounted upper jaw and the second jaw is a movable lower jaw. The support structure includes a first arcuate portion fixedly mounted to the end cap and to which the upper jaw is fixedly mounted. A second arcuate portion is pivotally mounted to the first arcuate portion and to which the lower jaw is fixedly mounted for pivotally engaging the upper jaw. A longitudinal rod is pivotally connected to the second arcuate portion and configured for passing through the opening in the end cap such that linear displacement of the movable connector produces pivotal displacement of the longitudinal rod, thereby pivotally displacing the lower jaw into engagement with the upper jaw.

In another aspect, the first and second jaws are curved pieces having concave interior surfaces disposed in a facing arrangement in order to define gripping surfaces for the object. The object is a removable grounding clamp for connecting to electrical components. A thumbscrew is retained in a bore in the sidewall of the end cap. The thumbscrew is tightened so that an end of the thumbscrew applies a securing force against the hot stick to thereby secure the end cap onto the operative end of the hot stick.

In another aspect, a method is provided of attaching a grounding clamp to an electrical component. The method includes steps of removably mounting and connecting a clamp device to an electrical hot stick and gripping the grounding clamp between first and second jaws of the clamp device so that jaws of the grounding clamp are in an open position. The gripping of the grounding clamp is retained between the first and second jaws of the clamp device by biasing a tensioning component of the hot stick to retain the jaws of the grounding clamp in the open position. The hot stick is extended to place the grounding clamp onto a high voltage electrical component. The tensioning component of the hot stick is released to release the first and second jaws of the clamp device and thereby release the jaws of the grounding clamp into a closed position and thus retain the grounding clamp upon the high voltage electrical component. The hot stick is then removed from the high voltage electrical component.

In another aspect, the tensioning component includes a spring biased rachet device so that the step of gripping biases the rachet. Releasing the rachet separates the first and second jaws, thereby releasing the clamp device and enabling the hot stick to be removed. The step of removably mounting the clamp device to an electrical hot stick includes mounting an end cap of the clamp device to an operative end of the hot stick. The step of mounting the end cap includes engaging a loop retained within an interior portion of the end cap with a hook received internally within the operative end of the hot stick. The loop is mechanically connected to the first and second jaws of the clamp device so that the step of retaining the gripping of the grounding clamp includes displacing a rod of the hot stick to internally displace the hook and thereby correspondingly displace the first and second jaws of the clamp device so that jaws of the grounding clamp are in the open position. The step of mounting the end cap further includes a step of tightening a thumbscrew through a bore in the sidewall of the end cap so that an end of the thumbscrew applies a securing force against the hot stick, to thereby secure the end cap onto the operative end of the hot stick.

Other benefits and advantages of this invention will become apparent to those skilled in the art to which it pertains upon reading and understanding of the following detailed specification.

### III. BRIEF DESCRIPTION OF THE DRAWINGS

The disclosed clamp device may take physical form in certain parts and arrangement of parts, embodiments of which will be described in detail in this specification and illustrated in the accompanying drawings which form a part hereof and wherein:

FIG. 1 depicts the present clamp device prior to engagement with a hot stick in accordance with an embodiment of the present invention.

FIG. 2 depicts the present clamp device internally engaged with a hook of the hot stick in accordance with the embodiment of the present invention.

FIG. 3 is a rear view of the present clamp device mounted over the top of the hot stick and internally engaged with the hook in accordance with the embodiment of the present invention.

FIG. 4 is a side view of the present clamp device mounted over the top of the hot stick and internally engaged with the hook in accordance with the embodiment of the present invention.

FIG. 5 is a front view of the present clamp device mounted over the top of the hot stick and internally engaged with the hook in accordance with the embodiment of the present invention.

FIG. 6 depicts inserting a removable grounding clamp to the present clamp device mounted onto the hot stick in accordance with the embodiment of the present invention.

FIG. 7 depicts the loading of jaws of the present clamp device mounted onto the hot stick to open the removable grounding clamp in accordance with the embodiment of the present invention.

FIG. 8 depicts placement of the removable grounding clamp onto a conductor using the present clamp device in accordance with the embodiment of the present invention.

FIG. 9 depicts the removal of the present clamp device mounted onto the hot stick after placement of the removable grounding clamp onto the conductor in accordance with the embodiment of the present invention.

FIG. 10 depicts the engagement of the removable grounding clamp placed on the conductor using the present clamp device mounted onto the hot stick in accordance with the embodiment of the present invention.

FIG. 11 depicts the release of the removable grounding clamp from the conductor using the present clamp device mounted onto the hot stick in accordance with the embodiment of the present invention.

FIG. 12 depicts the removal of the removable grounding clamp from the conductor using the present clamp device mounted onto the hot stick in accordance with the embodiment of the present invention.

FIG. 13 depicts the engagement of a removable grounding clamp placed on the conductor using the present clamp device mounted onto the hot stick in accordance with an alternate embodiment of the present invention.

FIG. 14 is a side view of the alternate embodiment of the present clamp device mounted over the top of the hot stick showing an engagement position in accordance with the alternate embodiment of the present invention.

FIG. 15 is a side view of the alternate embodiment of the present clamp device mounted over the top of the hot stick showing a disengagement position in accordance with the alternate embodiment of the present invention.

### IV. DETAILED DESCRIPTION

Reference is now made to the drawings wherein the showings are for purposes of illustrating embodiments of the article only and not for purposes of limiting the same, and wherein like reference numerals are understood to refer to like components.

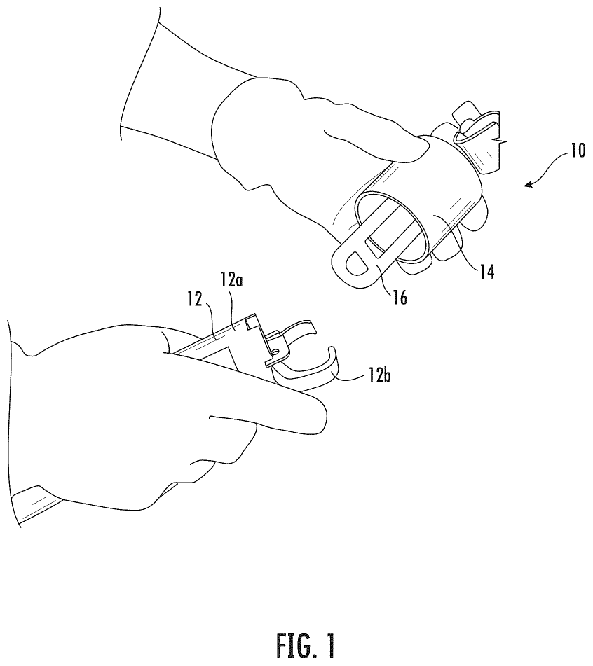

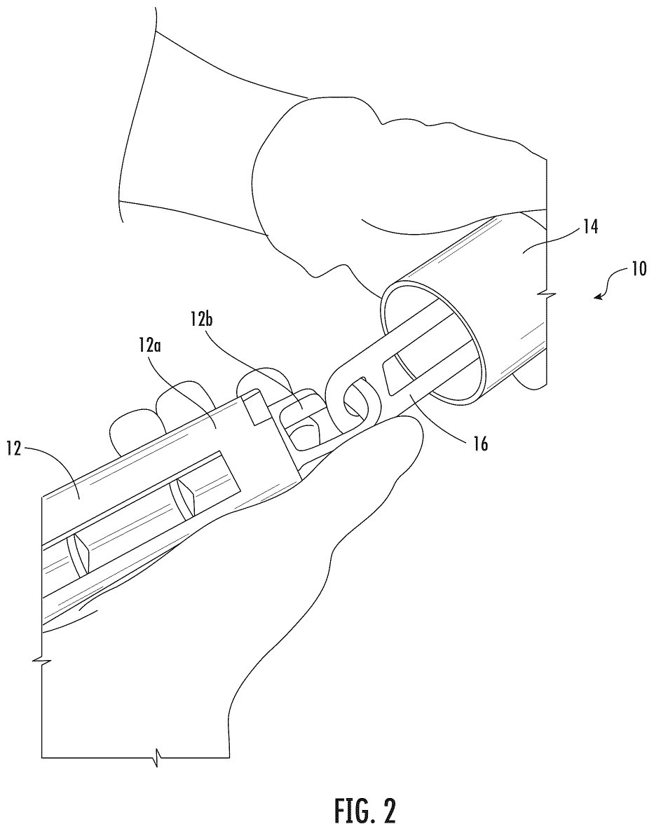

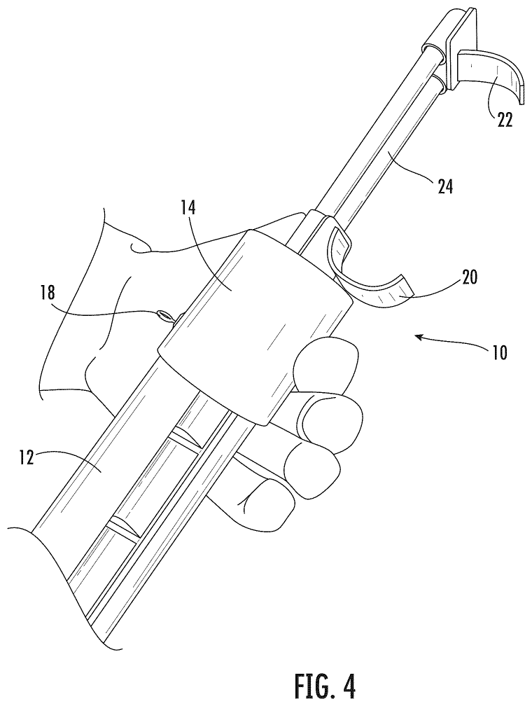

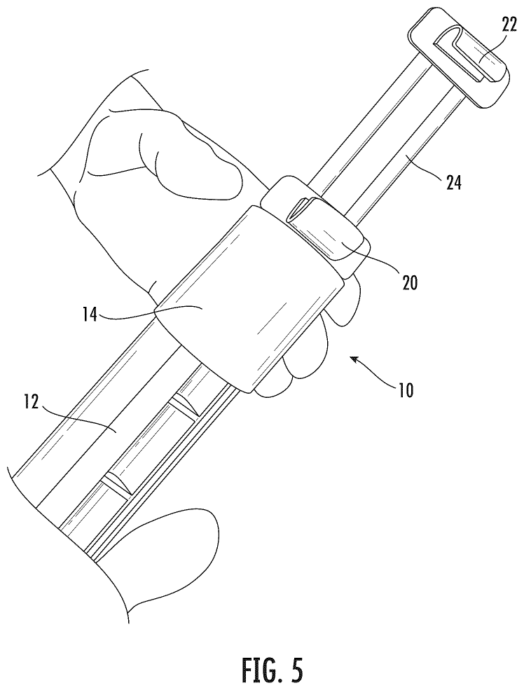

As shown in the embodiment of FIGS. 1-5, a clamp device 10 is removably mounted to an electrical hot stick 12. The removable clamp 10 includes an end cap 14 that covers the operative end 12a of the hot stick 12. A loop 16 is retained within the interior portion of the end cap 14 that engages a hook 12b received internally within the operative end 12a of the hot stick 12. After the hook 12b is inserted through the loop 16, the end cap 14 is slid down onto the operative end 12a to mount the clamp 10 securely into the hot stick 12. A thumbscrew 18 is retained in a bore in the sidewall 14a of the end cap 14. The thumbscrew 18 is tightened so that an end of the thumbscrew 18 applies a securing force against the hot stick 12, to thereby secure the end cap 14 onto the operative end 12a of the hot stick 12, where the operative end 12a is located along the hot stick 12 at a position opposite a worker end held by a worker.

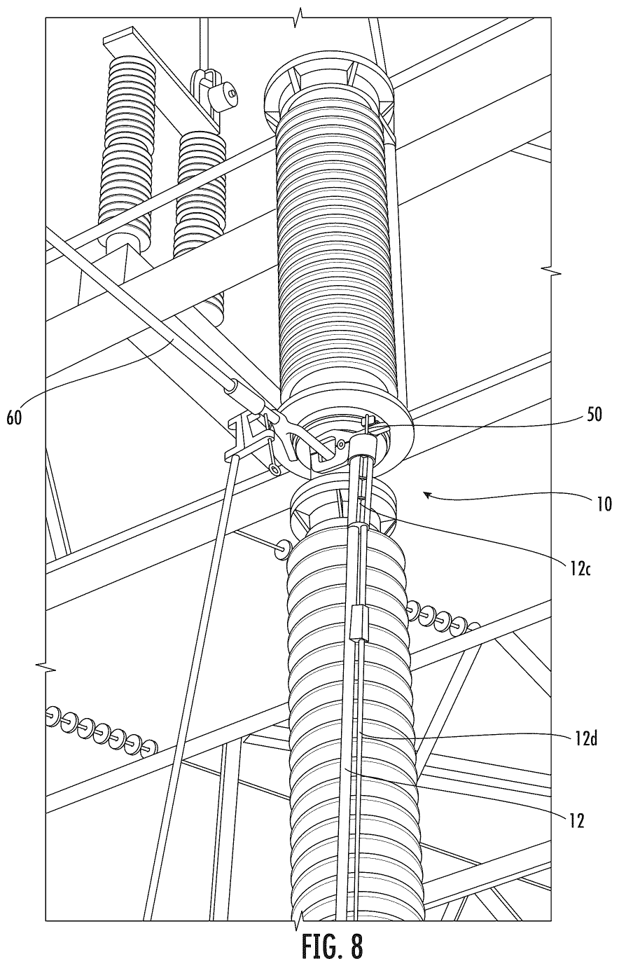

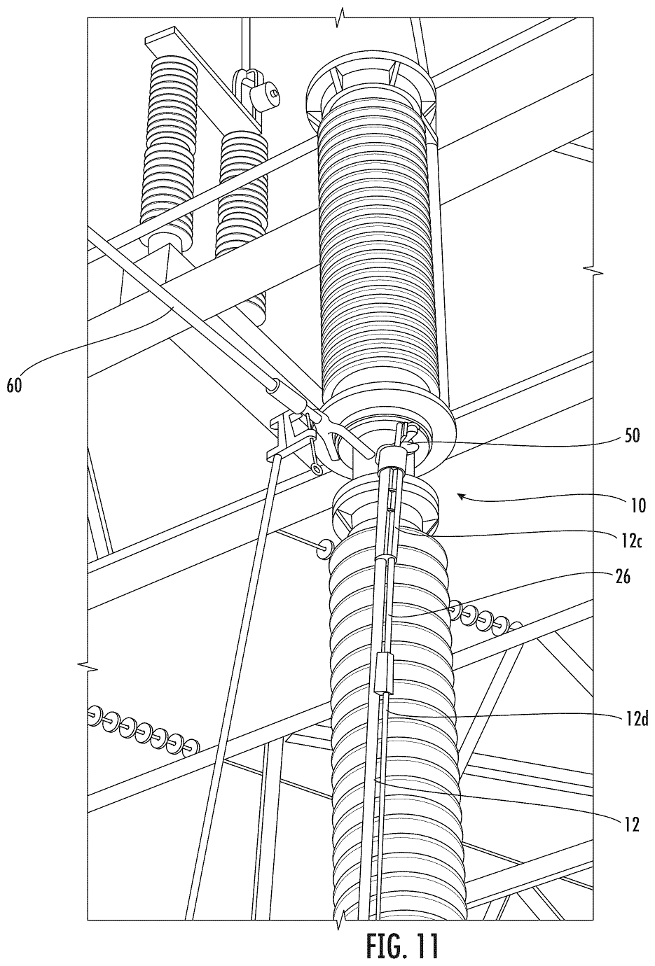

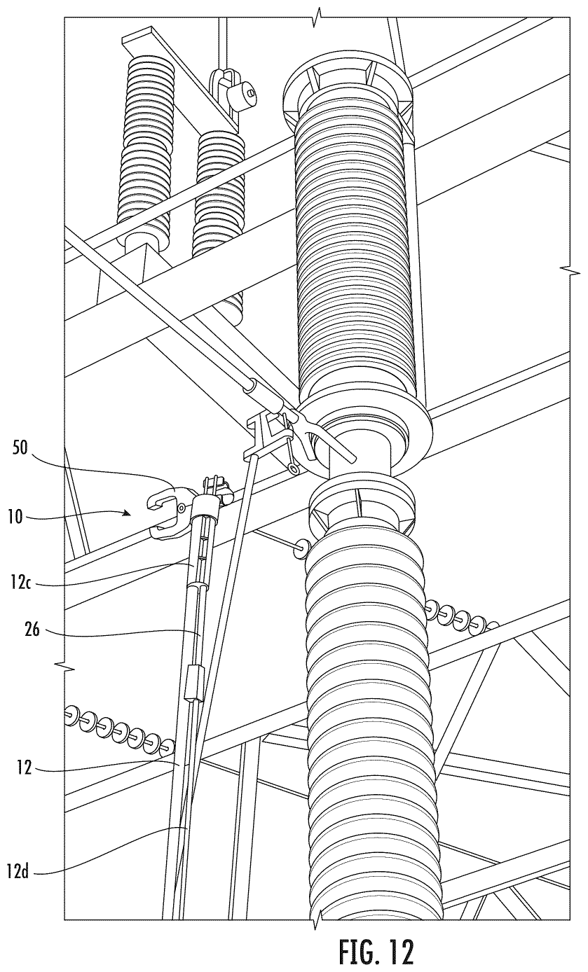

As shown in particularly in FIGS. 8-13 and described herein, the present clamp device 10 is employed on high voltage electrical components using a hot stick 12. Hot sticks (also known as shotgun sticks) are typically formed as longitudinal poles made of fiberglass or other insulating material to provide safety to workers. The poles can include an adjoining reciprocating rod 12c, mounted alongside the hot stick 12, that can be moved back and forth via a handle at the worker end to displace the hook 12a received internally at the operative end 12a. The hot stick 12 includes an end component 12d proximal to the operative end 12a of the hot stick 12 and further includes an internal spring loaded rachet structure located inside the end component 12d. The internal rachet structure is configured selectively lock and unlock the hook 12b in extended and unextended positions. The present clamp device 10 can be mounted atop a hot stick (or shotgun stick) of the type manufactured and sold by vendors including Hastings Fiber Glass Products of Hastings, Michigan, or any other suitable type of hot stick manufactured by another company.

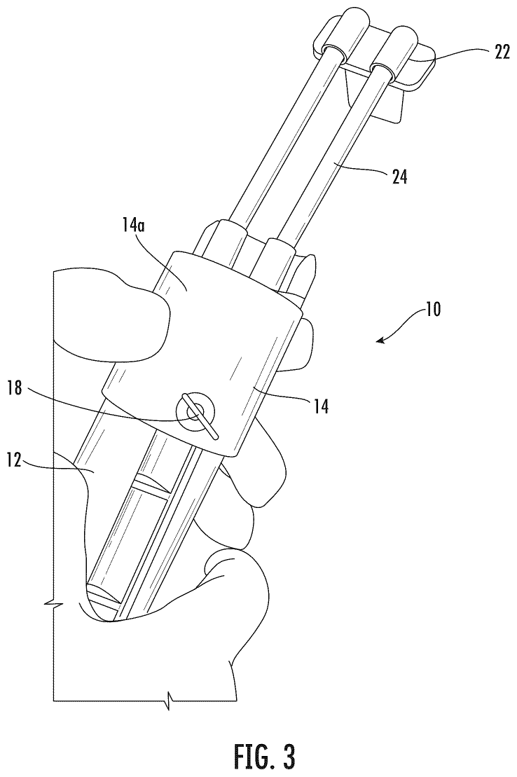

As shown in FIGS. 3-5, the clamp 10 includes two clamp jaws 20, 22. A lower jaw 20 is fixedly secured to the top of the end cap 14 via welding or another similar securement. An upper jaw 22 is movably mounted atop a support structure 24 to engage the lower jaw 20 and thereby secure an object such as a removable grounding clamp between the jaws 20, 22. As shown, the jaws 20, 22 are curved pieces having concave interior surfaces disposed in a facing arrangement in order to define gripping surfaces for the object. As also shown, the support structure 24 can be a pair of parallel bars that movably extend out from the end cap. However, any jaw configuration or suitable support could be alternatively employed without departing from the invention.

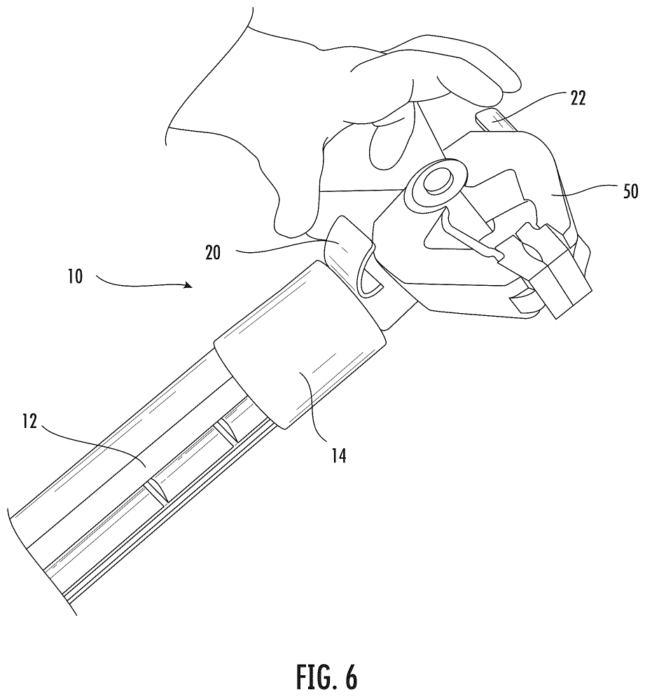

As indicated by FIGS. 1-5, the end cap 14 has a generally cylindrical side wall 14a having an open cylindrical end and a closed cylindrical end. The open cylindrical end receives the operative end of the hot stick 12 and the closed cylindrical end is a solid piece formed integrally with the cylindrical side wall 14a and includes an opening for passing through the support structure 24. The loop 16 is connected to the support structure 24 which passes through the opening so that movement or displacement of the loop 16 results in corresponding movement or displacement of the upper jaw 22. Movement of the reciprocating rod 12c of the hot stick 12 by the worker results in movement of the hook 12b and thereby movement of the loop 16 and thus the upper jaw 22. As shown in FIG. 6 the object is placed between the lower and upper jaws 20, 22 which are compressed to grip the object in the engagement position.

The upper jaw 22 and the support structure 24 are retained in the engagement position by force exerted by the internal spring loaded rachet structure located inside the end component 12d, as shown in FIGS. 8-13. As shown, the support structure 24 is formed of a pair of parallel bars that slidably pass through a respective pair of openings in the end cap 14, and the upper jaw 22 is fixedly mounted to both parallel bars. The support structure 24 is drawn downwardly into the end cap 14 by movement of transmitted form the reciprocating rod 12c which engages the rachet and thereby prevents upward movement of the upper jaw 22 until the rachet is released. The rachet thus retains the support structure 24 and the upper jaw 22 in a fixed position with respect to the end cap 14, thereby securing the object between the jaws 20, 22.

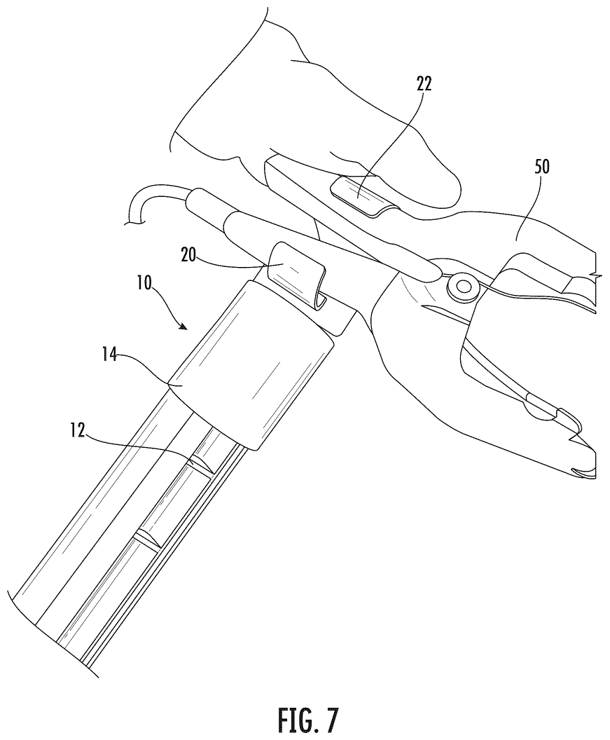

As shown in FIGS. 6 and 7, the object retained in the clamp device 10 can be a type of removable grounding clamp 50 with a wire attached that can be removably attached to a power line, for grounding or measuring an electrical parameter (voltage, current, signal, etc.). The rachet within the end component 12d of the hot stick 12 can be biased to maintain the jaws 20, 22 in engagement over the grounding clamp 50 and retaining the jaws of the grounding clamp 50 in an open position for attachment to the high voltage electrical component. The 20, 22 of the clamp 10 are configured at a 90-degree angle from the hot stick 12. In this manner the present invention allows the worker to squeeze the grounding clamp 50 between the jaws 20, 22 and place the claim 50 on a structure or device that is horizontal to the ground.

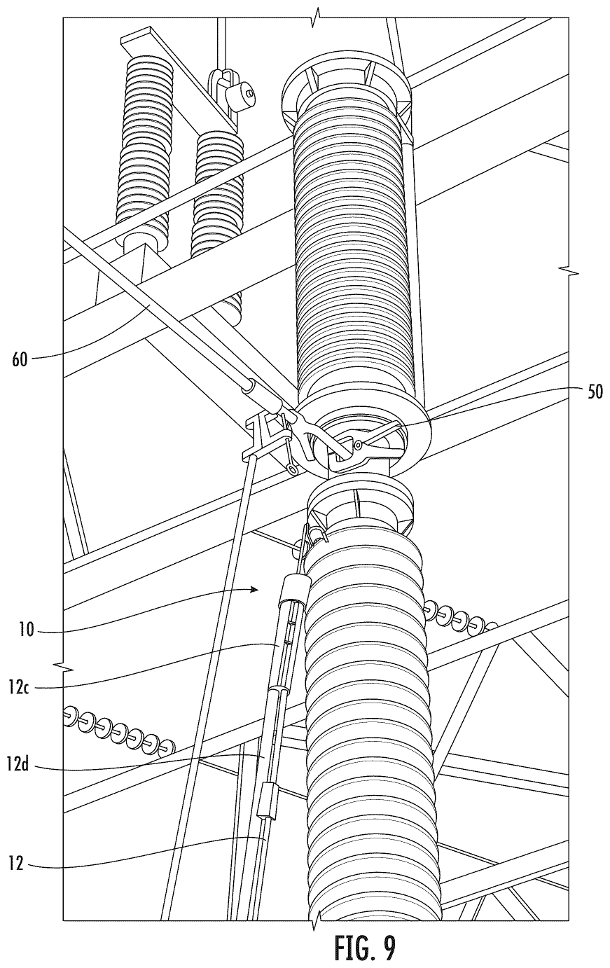

As shown in FIGS. 8 and 9, the grounding clamp 50 is gripped inside the clamp 10, set atop the hot stick 12, and can be extended to a high voltage power line 60. The grounding clamp 50 is set in place on the line 60. The grounding clamp 50 is released by reversing the direction of the reciprocating rod 12c on the hot stick 12 which releases the rachet when pushed upward by the worker at the end of the hot stick 12. This releases the support structure 24 which springs back outwardly to separate the upper and lower jaws, 20, 22, thereby releasing the clamp device 10 and enabling the hot stick 12 to be removed.

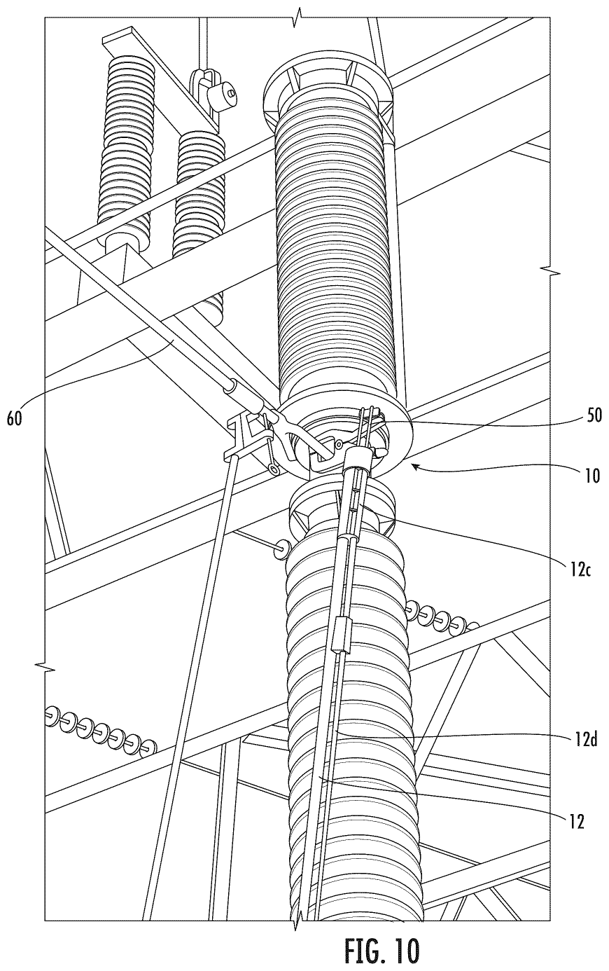

In a reverse operation, as shown in FIGS. 10-12, the grounding clamp 50 can be removed from the high voltage power line 60 by extending the clamp 10, set atop the hot stick 12, to grip the grounding clamp 50. The reciprocating rod 12c on the hot stick 12 can be pulled by the user at the end of the hot stick 12 which pulls the support structure 24 and draws the upper jaw 22 together with the lower jaw 20, 22, thereby gripping the clamp device 10 unto the grounding clamp 50. This opens the jaws of the grounding clamp 50 to release the line 60 and thereby enabling the hot stick 12 and grounding clamp 50 to be removed. In the aforementioned manner, the present clamp device 10 can be selectively engaged and released, in order to attach and remove the grounding clamp 50 from the power line 60.

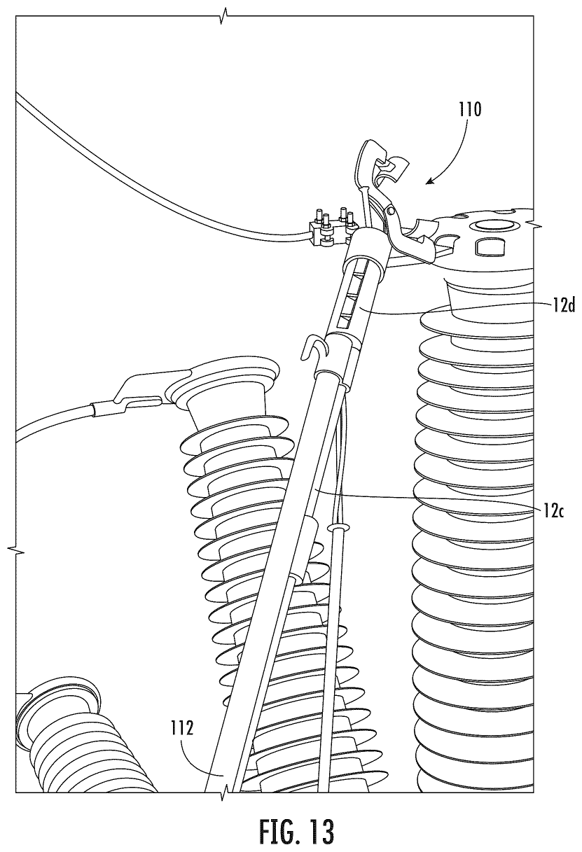

FIGS. 13-15 depicts an alternate embodiment of the present clamp device 110 for mounting on a hot stick 112 along with engagement and disengagement positions. In this alternate embodiment the upper jaw 122 is fixedly mounted and the lower jaw 120 is movable. The support structure 124 includes a first arcuate portion 124a fixedly mounted to the end cap 114 and to which the upper jaw 124 is fixedly mounted. A second arcuate portion 124b is pivotally mounted to the first arcuate portion 124a. The lower jaw 120 is fixedly mounted to the second arcuate portion 124b for pivotally engaging the upper jaw 122. The support structure 124 further includes a longitudinal rod 124c pivotally connected to the second arcuate portion 124b and configured for passing through the opening in the end cap 114 such that linear displacement of the reciprocating rod 12c of the hot stick 112 through the hook 12b and loop 16 produces pivotal displacement of the longitudinal rod 124c, thereby pivotally displacing the lower jaw 120 into engagement with the upper jaw 122.

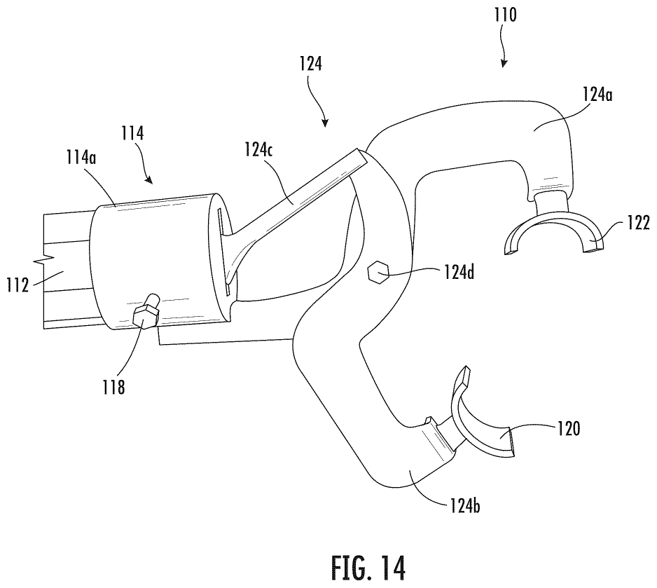

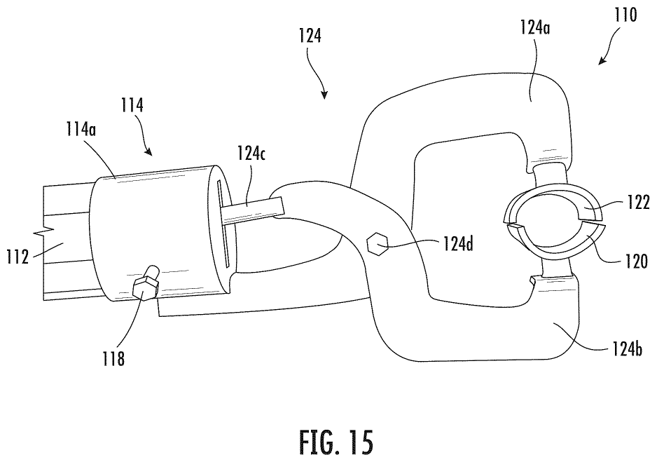

As shown in FIGS. 14 and 15 the arcuate portions 124a, 124b are generally S-shaped with a pivot structure (e.g., a bolt) mounted in the respective centers to enable reciprocal pivoting. In this alternate embodiment of the clamp device 10 the jaws 120, 122 open and close in a scissor like action and are attached to the hot stick 112 in the same fashion as the first embodiment described hereinabove so that a grounding clamp 50 is placed into an electrical device and the handles of the clamp 50 are squeezed together horizontally. The jaws that hold the clamp can also rotate, allowing the user to adjust the angle of the clamp as needed. Contrary to the horizontal configuration of the first embodiment, the jaws 120, 122 of the alternate clamp device 110 can be positioned vertically and inline with the hot stick 112 thereby allowing the user to attach the grounding clamp 50 to electrical structures directly overhead. The grounding clamp 50 can also be rotated down to a 90-degree angle from the hot stick 12 thereby allowing the worker to attach the clamp 50 to structures that are more vertical.

With this present clamp devices 10, 110 attached to a hot stick 12, 112 the worker can attach the grounding clamp 50 on to the terminal at the top of the equipment being tested while standing safely on the ground, as high as the hot stick 12 can reach and as far as the leads for the test equipment can stretch out. These present clamp devices 10, 110 keep the worker on the ground, eliminating the potential of falling off a ladder.

In an example, testing contact resistance can be performed on a 230 kV three phase circuit breaker where the terminals are 25 feet off the ground. The worker can stretch out the two test leads needed to run the test and plug one end into the box of the test equipment. Then using the present clamps 10, 110 with a hot stick 12, 112 the grounding claim 50 can be squeezed and lifted up to the top of the terminal where the clamp 50 can be released using the normal operations of the hot stick 12, 112. The worker or technician can then walk around and connect a second clamp 50 to a bushing on the other end of that phase or pole, run the contact resistance test on that pole/phase, then proceed to moving the clamps 50 to the next pole/phase until all three phases are completed.

In the aforementioned manner, the present clamp devices 10, 110 shorten the amount of time and lower the cost needed to test equipment, specifically circuit breakers, insofar as reducing or eliminating the cost of providing a manlift or bucker truck for one as well as reducing the extra time spent repositioning that equipment to reach each bushing terminal, now requiring a longer time to stretch out the cables than to attach the grounding clamp 50 onto the terminal, resulting in improved efficiency and reduction in time and overall cost for performing the operations.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A clamp device for removable mounting to an electrical hot stick, comprising:
an end cap having a sidewall enclosing a hollow interior for receiving an operative end of the hot stick;
a first jaw fixedly mounted to the end cap;
a second jaw configured for movably engaging the first jaw to grip an object;
a support structure to which the second jaw is fixedly mounted, the support structure passing through an opening in the end cap and movably connected to one of the end cap or first jaw such that the second jaw engages the first jaw upon displacement of the support structure; and
a connector of the support structure for connecting to a movable connector of the hot stick such that the support structure is displaced upon displacement of the movable connector, thereby engaging the second jaw with the first jaw to grip the object, wherein a reverse displacement of the movable connector releases the object.

2. The clamp device of claim 1, wherein the end cap has a generally cylindrical side wall having an open cylindrical end and a closed cylindrical end wherein the open cylindrical end receives the operative end of the hot stick and the closed cylindrical end is a solid piece formed integrally with the cylindrical side wall and includes the opening for passing through the support structure.

3. The clamp device of claim 1, wherein the movable connector of the hot stick is a hook and the connector of the support structure is a loop to which the hook is connected.

4. The clamp device of claim 1, wherein the first jaw is a lower jaw fixedly mounted to the end cap and the second jaw is a movable upper jaw, wherein the support structure comprises at least one longitudinal bar configured for slidably passing through the opening in the end cap such that linear displacement of the movable connector produces linear displacement of the support structure, thereby linearly displacing the upper jaw into engagement with the lower jaw.

5. The clamp device of claim 4, wherein the support structure comprises a pair of parallel bars that slidably pass through a respective pair of openings in the end cap, wherein the upper jaw is fixedly mounted to both parallel bars.

6. The clamp device of claim 1, wherein the first jaw is a fixedly mounted upper jaw and the second jaw is a movable lower jaw, wherein the support structure comprises:
a first arcuate portion fixedly mounted to the end cap and to which the upper jaw is fixedly mounted;
a second arcuate portion pivotally mounted to the first arcuate portion and to which the lower jaw is fixedly mounted for pivotally engaging the upper jaw;
a longitudinal rod pivotally connected to the second arcuate portion and configured for passing through the opening in the end cap such that linear displacement of the movable connector produces pivotal displacement of the longitudinal rod, thereby pivotally displacing the lower jaw into engagement with the upper jaw.

7. The clamp device of claim 1, wherein the first and second jaws are curved pieces having concave interior surfaces disposed in a facing arrangement in order to define gripping surfaces for the object.

8. The clamp device of claim 1, wherein the object is a removable grounding clamp for connecting to electrical components.

9. The clamp device of claim 1, further comprising a thumbscrew retained in a bore in the sidewall of the end cap, wherein the thumbscrew is tightened so that an end of the thumbscrew applies a securing force against the hot stick to thereby secure the end cap onto the operative end of the hot stick.

10. A method of attaching a grounding clamp to an electrical component, comprising steps of:
removably mounting and connecting a clamp device to an electrical hot stick;
gripping the grounding clamp between first and second jaws of the clamp device so that jaws of the grounding clamp are in an open position;
retaining the gripping of the grounding clamp between the first and second jaws of the clamp device by biasing a tensioning component of the hot stick to retain the jaws of the grounding clamp in the open position;
extending the hot stick to place the grounding clamp onto a high voltage electrical component;
releasing the tensioning component of the hot stick to release the first and second jaws of the clamp device and thereby release the jaws of the grounding clamp into a closed position and thus retain the grounding clamp upon the high voltage electrical component; and
removing the hot stick from the high voltage electrical component.

11. The method of claim 10, wherein the tensioning component comprises a spring biased rachet device wherein the step of gripping biases the rachet and releasing the rachet separates the first and second jaws, thereby releasing the clamp device and enabling the hot stick to be removed.

12. The method of claim 10, the step of removably mounting the clamp device to an electrical hot stick comprises mounting an end cap of the clamp device to an operative end of the hot stick.

13. The method of claim 12, wherein the step of mounting the end cap comprises engaging a loop retained within an interior portion of the end cap with a hook received internally within the operative end of the hot stick.

14. The method of claim 13, wherein the loop is mechanically connected to the first and second jaws of the clamp device and wherein the step of retaining the gripping of the grounding clamp comprises displacing a rod of the hot stick to internally displace the hook and thereby correspondingly displace the first and second jaws of the clamp device so that jaws of the grounding clamp are in the open position.

15. The method of claim 10, wherein the step of mounting the end cap further comprises a step of tightening a thumbscrew through a bore in the sidewall of the end cap so that an end of the thumbscrew applies a securing force against the hot stick, to thereby secure the end cap onto the operative end of the hot stick.
